(19) United States
(12) Patent Application Publication
(10) Pub. No.: US 2003/0159640 A1
(43) Pub. Date: Aug. 28, 2003

(54) Bookmark

(76) Inventor: Karmen Payne, Costa Mesa, CA (US)

Correspondence Address: Matthew J. Peirce, Esq., 1550 Starlight Canyon Avenue, Las Vagas, NV, 89123, US

(21) Appl. No.: 10/083,433

(22) Filed: Feb. 27, 2002

(51) Int. Cl. B42D 9/00

(52) U.S. Cl. 116/238

(57) ABSTRACT

A new and improved bookmark is disclosed for allowing people to mark more than one place in a book while reading, studying, or teaching. The bookmark would comprise a clip, a base, a clip tongue, and a plurality of ribbons which would be attached to the base. The base would be placed against the upper edge of the central binder in a book in which a user would wish to place the present invention. The clip would be attached to the outside of the binder in order to securely attach the present invention to the book. The clip tongue would be attached to the inside of the binder in order to securely attach the present invention to the book. The ribbons would be attached to the base, and the ribbons would be designed to extend about six to nine inches in order to ensure that each ribbon could be used to adequately mark a specific page within a particular book.

### I. BACKGROUND OF THE INVENTION

The present invention is that of a new and improved bookmark for allowing people to mark more than one place in a book while reading, studying, or teaching.

### II. DESCRIPTION OF THE PRIOR ART

U.S. Pat. No. 5,443,029, issued to Garnet, discloses an improved bookmark which includes a body having one surface substantially covered by an adhesive layer for mounting the body on a book.

U.S. Pat. No. 5,408,950, issued to Porto, discloses a combination bookmark display device which includes a head portion and a body portion.

U.S. Pat. No. 2,645,197, issued to Jones, discloses a bookmark which is designed to facilitate convenient and expeditious opening of a book at several different passages in a predetermined order or sequence.

### III. SUMMARY OF THE INVENTION

The present invention is that of a new and improved bookmark for allowing people to mark more than one place in a book while reading, studying, or teaching. The bookmark would comprise a clip, a base, a clip tongue, and a plurality of ribbons which would be attached to the base. The base would be placed against the upper edge of the central binder in a book in which a user would wish to place the present invention. The clip would be attached to the outside of the binder in order to securely attach the present invention to the book. The clip tongue would be attached to the inside of the binder in order to securely attach the present invention to the book. The ribbons would be attached to the base, and the ribbons would be designed to extend about six to nine inches in order to ensure that each ribbon could be used to adequately mark a specific page within a particular book.

There has thus been outlined, rather broadly, the more important features of a bookmark in order that the detailed description thereof that follows may be better understood and in order that the present contribution to the art may be better appreciated. There are, of course, additional features of the bookmark that will be described hereinafter and which will form the subject matter of the claims appended hereto.

In this respect, before explaining at least one embodiment of the bookmark in detail, it is to be understood that the bookmark is not limited in its application to the details of construction and to the arrangements of the components set forth in the following description or illustrated in the drawings. The bookmark is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present bookmark. It is important, therefore, that the claims be regard as including such equivalent constructions insofar as they do not depart from the spirit and scope of the present invention.

It is therefore an object of the present invention to provide a bookmark which has all of the advantages of the prior art and none of the disadvantages.

It is another object of the present invention to provide a bookmark which may be easily and efficiently manufactured and marketed.

It is another object of the present invention to provide a bookmark which is of durable and reliable construction.

It is yet another object of the present invention to provide a bookmark which is economically affordable and available to the buying public.

It is yet another object of the present invention to provide a bookmark which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a side view of the present invention.

FIG. 3 shows a perspective view of the present invention in use.

### V. DESCRIPTION OF THE PREFERRED EMBODIMENT

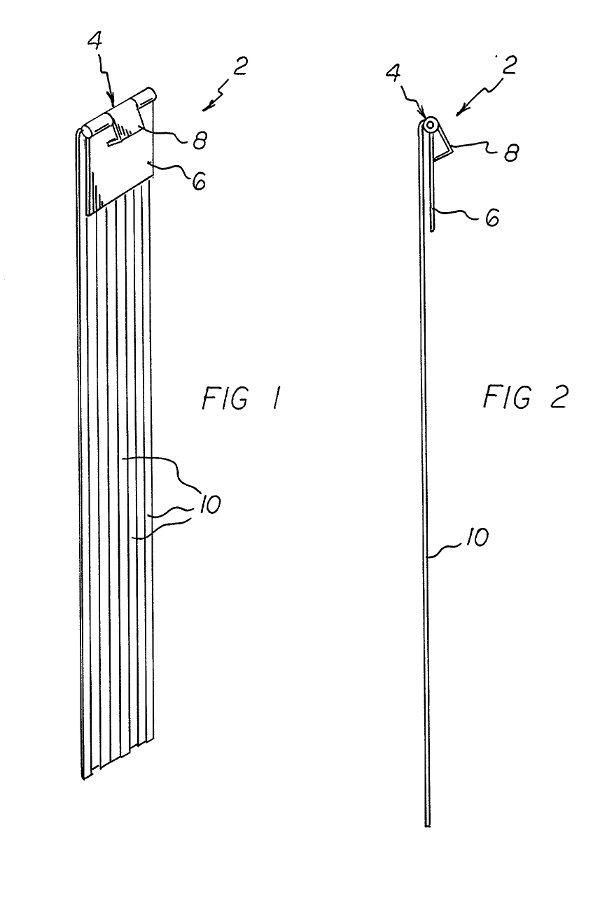

FIGS. 1 and 2 show perspective and side views, respectively, of the present invention. The present invention is that of a new and improved bookmark 2 for allowing people to mark more than one place in a book while reading, studying, or teaching. The bookmark 2 would comprise a base 4, a clip 6, a clip tongue 8, and a plurality of ribbons 10 which would be attached to the base 4. The base 4 and clip 6 would be placed against the upper edge of a central binder 12 in a book 14 in which a user would wish to place the bookmark 2. The clip 6 would be attached to the outside of the binder 12 in order to securely attach the present invention to the book 14. The clip tongue 8 would be attached to the inside of the binder 12 in order to securely attach the bookmark 2 to the book 14. The binder 12 would have an inside surface and an outside surface, and also would have a front cover, rear cover, and a connector portion

Each ribbon 10 would be attached to the base 4, and each ribbon 10 would be designed to extend about six to nine inches from its attachment point with base 4 in order to ensure that each ribbon 10 could be used to adequately mark a specific page within a particular book 14.

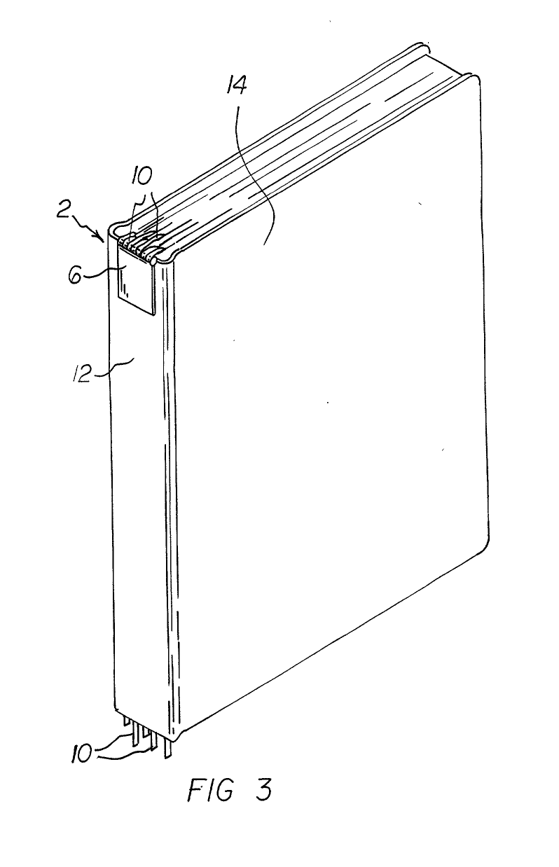

FIG. 3 shows a perspective view of the present invention in use. In use, a user would place base 4 and clip 6 of bookmark 2 against the upper edge of a central binder 12 in book 14. Clip 6 would be attached to the outside of the binder 12 in order to securely attach the bookmark 2 to book 14. The clip tongue 8 would be attached to the inside of the binder 12 in order to securely attach the bookmark 2 to the book 14. Each ribbon 10 would be attached to the base 4, and each ribbon 10 would be designed to extend about six to nine inches from its attachment point with base 4 in order to ensure that each ribbon 10 could be used to adequately mark a specific page within a particular book 14. While reading or otherwise using book 14, a user could place individual ribbons 10 on specific pages within book 14 that a user would want to properly mark for later retrieval and/or use. The number of ribbons 10 used with the present invention could be any number, but preferably would either be five or ten.

In an alternative embodiment of the present invention, the ribbons 10 would be attached to the clip 6 instead of the base 4. This embodiment would have practically the same functionality of the preferred embodiment disclosed herein.

What I claim as my invention is:

1. A bookmark comprising:
(a) a circular base,
(b) a clip fixedly attached to the circular base,
(c) a clip tongue pivotally attached to the clip tongue,
(d) a plurality of ribbons, each ribbon having two ends, a first end and a second end, the first end of each ribbon being attached to the circular base, and
(e) means for providing pivotal force for the clip tongue to push against the clip.

2. A bookmark according to claim 1 wherein each ribbon would be approximately nine inches long.

3. A bookmark according to claim 2 wherein the plurality of ribbons would preferably comprise five ribbons.

4. A bookmark according to claim 2 wherein the plurality of ribbons would preferably comprise ten ribbons.

5. A bookmark according to claim 2 in combination with a book, the book including a binder that includes an inside surface and an outside surface, the binder having a front cover, rear cover, and a connector portion, wherein the clip would be attached to the outside surface of the connector portion of the binder and the clip tongue would be attached to the inside surface of the connector portion, and further wherein the user would place individual ribbons between selected pages in the book.

6. A bookmark comprising:
(a) a circular base,
(b) a clip fixedly attached to the circular base,
(c) a clip tongue pivotally attached to the clip tongue,
(d) a plurality of ribbons, each ribbon having two ends, a first end and a second end, the first end of each ribbon being attached to the clip, and
(e) means for providing pivotal force for the clip tongue to push against the clip.

7. A bookmark according to claim 6 wherein each ribbon would be approximately nine inches long.

8. A bookmark according to claim 7 wherein the plurality of ribbons would preferably comprise five ribbons.

9. A bookmark according to claim 7 wherein the plurality of ribbons would preferably comprise ten ribbons.

10. A bookmark according to claim 7 in combination with a book, the book including a binder that includes an inside surface and an outside surface, the binder having a front cover, rear cover, and a connector portion, wherein the clip would be attached to the outside surface of the connector portion of the binder and the clip tongue would be attached to the inside surface of the connector portion, and further wherein the user would place individual ribbons between selected pages in the book.
